(19) United States
(12) Patent Application Publication
(10) Pub. No.: US 2010/0057602 A1
(43) Pub. Date: Mar. 4, 2010

(54) Electronic trading GUI

(76) Inventor: Ercan S. Armutcu, Tokyo (JP)

Correspondence Address: Paul E Schaafsma, NovusIP, LLC, Suite 221, 521 West Superior Street, Chicago, IL, 60654, US

(21) Appl. No.: 12/229,986

(22) Filed: Aug. 28, 2008

(51) Int. Cl. G06Q 40/00; G06F 3/00

(52) U.S. Cl. 705/37; 715/700

(57) ABSTRACT

In accordance with the principles of the present invention, a graphical user interface for computer trading is provided. A display represents best bid and best ask prices for an execution venue, with one axis representing available prices, and another axis representing time. The display includes a sell area, a bid-ask spread, and a buy area. The boundary of the sell area and the bid-ask spread represents best ask price for the execution venue, and the boundary of the buy area and the bid-ask spread represents best bid price for the execution venue. First indicium on the display represents order executions and second indicium on the display represents orders. The position of the first indicium represents the time and price of the execution, the size represents the size or quantity of the execution, and the colour represents execution type and execution venue. The position of the second indicium represents the price of the order; the size represents the duration of the order, and the colour represents the order type and posted exchange venue. The second indicium can further comprise a transparency representing the size of the order.

### FIELD OF THE INVENTION

The present invention relates to computerized trading systems.

### BACKGROUND OF THE INVENTION

At one time, there were only open-outcry exchanges where brokers and traders, or more specifically buyers and sellers, would come together to trade in person. More recently, electronic exchanges that process automatic and electronic matching of bids and offers have been introduced. Thus, trading methods have evolved from a manually intensive process to a technology enabled, electronic platform.

Many exchanges throughout the world implement electronic trading in varying degrees to match buyers and sellers of tradeable objects, where a tradeable object refers simply to anything that can be traded. Tradeable objects may include, but are not limited to, all types of traded financial products, such as, for example, stocks, options, bonds, futures, currency, and warrants, as well as funds, derivatives, and collections of the foregoing, and all types of commodities, such as grains, energy related products, and metals.

Electronic trading has made it easier for people in diverse geographic locations to more efficiently participate in the financial markets. With the advent of electronic trading, a trader can be in direct contact simultaneously with multiple markets, from practically anywhere in the world, performing near real-time transactions, all without the need to make personal contact with a broker for a trade. The lack of manual intervention required to trade has led to a sharp decline in transactions costs, both in the form of exchange and processing fees as well as brokerage fees. Declining costs, more efficient executions, as well as macroeconomic trends, have resulted in a general increase in trading activity as trading has migrated from traditional floor execution to various electronic platforms. The increase in the number of market participants and lower transaction costs has generally led to more competitive markets and greater liquidity.

Electronic trading is generally based on host computers, one or more computer networks, and exchange participant's (client) computers. In general, the host exchange includes one or more centralized computers. The operations of the host exchange typically include order matching, maintaining order books and positions, price information, and managing and updating the database for the online trading day as well as nightly batch runs. The host exchange is also equipped with external interfaces that maintain contact to quote vendors and other price information systems.

Using client devices, market participants or traders link to the host exchange through one or more computer networks. A computer network is a group of two or more computers or devices linked together. There are many types of wired and wireless networks such as local area networks and wide area networks. Networks can also be characterized by topology, protocol, and architecture. For example, some market participants may link to the host through a direct connection such as a T1 or ISDN. Some participants may link to the host exchange through direct connections and through other common network components such as high-speed servers, routers, and gateways. The Internet can be used to establish a connection between the client device and the host exchange. There are many different types of networks and combinations of network types that can link traders to the host exchange.

Software running on client devices allows market participants to log onto one or more exchanges and participate in the market. A client device is a computer such as a personal computer, laptop computer, hand-held computer, and so forth that has network access. To effectuate an electronic order, a buy order or a sell order is sent by a client device to the host exchange. Upon receipt of the order, the host exchange determines if a match exists. More specifically, the host exchange checks the conditions associated with the order, for example order price and quantity, and compares the conditions associated with the order with orders resting in the host exchange electronic order book. If a match does not exist, the host exchange prioritizes the order with other orders (if any) in the electronic order book of the same price. (Some electronic markets prioritize orders first in the electronic order book and then attempt to match them). Priority may be dependent on the individual specification of the market. Generally, a match exists when the order conditions are satisfied in the market. If a match exists, then a fill confirmation message is commonly sent to the client device. In addition, all subscribing traders, including those involved in the trade, get some or all of the updated electronic order book information by way of new market information.

The market is fluid as many traders are sending orders to the market simultaneously; in fact, successful markets strive to have a high volume of trading such that any trader who wishes to enter an order will find a match and have the order filled quickly. In such liquid markets, the prices of the commodities can fluctuate rapidly. On a trading screen, this results in rapid changes in the price and quantity within the market. If a trader intends to enter an order at a particular price, but misses the price because the market prices moved before she could enter the order, she may experience a significant loss. The faster a trader can trade, the less likely it will be that he will miss his price and fail to execute his strategy.

Traders will rely on different venues to meet their specific trading needs at a given time. Variables for trading decisions can include size of order, liquidity profile of order, execution cost, market conditions, etc. As market fragmentation continues to increase (e.g., there are at least 35 potential execution venues for U.S. equities), and as new alternative trading systems (ATSs) enter what appears to be an already overcrowded U.S. equities market, it becomes increasingly challenging to keep track of executions and orders posted on different venues by computerized trading systems.

To transact effectively in electronic markets, market participants must be able to assimilate large amounts of data, including market information provided by public exchanges as well as multiple other execution venues, and react accordingly more quickly than other competing market participants. A skilled trader with the quickest software, the fastest communications, and the most sophisticated analytics can significantly improve his own or his firm's bottom line. The slightest speed advantage can generate significant returns in a fast moving market. In today's electronic markets, a trader lacking a technologically advanced interface is at a severe competitive disadvantage.

Access to host exchanges and real time market price data feeds is usually from an Execution Management Systems (EMS) or Order Management Systems (OMS). Traders can access the host exchange from their EMS or OMS, which typically are provided by third party software vendors. OMSs have been used for decades by asset managers for tracking and maintaining information about portfolios, trade orders, etc.

An OMS includes a “front end” (i.e., user interface) for entering and displaying order-type data as well as a “back end” (e.g., database) for storing and maintaining the underlying data; however, OMSs or EMSs do not typically include any pre-programmed instructions for buying or selling shares in a systematic way. As a result, if a trader wishes to utilize trading services of a brokerage firm, a customized trading user input front end must be built and interfaced with the third party OMS. After this, the OMS (or EMS) will use a network messaging protocol called Financial Information Exchange (FIX) protocol to connect the trader firm to the brokerage firm so that the trader firm can send orders to the brokerage firm for buying or selling shares.

A typical trade flow is illustrated in FIG. 1. From FIG. 1 it can be seen that computer trading makes up one part of the overall brokerage offering, and there are other ways for trader firms to execute their orders, including by telephoning/emailing in their orders to a sales trader working in the brokerage firm or trading directly with the exchange utilizing the systems provided by brokerage firms known as Direct Market Access (DMA).

An order which is sent to computerized trading system is non-limitingly referred to herein as a ‘parent order’. Once the parent order is received by the computerized trading system, it is split into smaller sized orders, non-limitingly referred to herein as ‘child orders’. Child orders are then sent to the host exchange to get executed. The general relationship between a parent order and child orders is ‘one-to-many’, as seen in FIG. 2.

The computerized trading system independently decides on the quantity of each child order, the venue to post to for that child order, the time of each child order, the total number of child orders, and the type of order (different venues provide different order types for users to post liquidity to or take liquidity from) of each child order it sends to the host exchange, based on pre-programmed computer and statistical models developed by the brokerage firm. The child orders that are sent to the various execution destinations depending on the selected order type for that venue are either executed immediately or cancelled (e.g., IOC ‘immediate or cancel’ order types) or ‘sit in the order book queue’, waiting to be executed at the price at which they were sent. These orders may be executed after some time, or they may be cancelled by the computerized trading system after a period of time.

Prior art EMSs or OMSs are presented in a tabular or matrix spread sheet format. Columns contain different performance metrics; although this is fine for getting snapshot information, it is not sufficient if one wants to understand the recent past behaviour of the computerized trading system—for example, what the computerized trading system did one hour ago—as this information might be updated in the spread sheet format. Even if there were ways to drill down in the spread sheet to get at past behaviour information, this would be time consuming, and most of the time, traders typically just want to get a ‘lay of the land’ view to see that the computerized trading system is on course in its execution trajectory. Prior art EMSs or OMSs do not provide an intuitive way to graphically visualize computerized trading system behaviour to give traders this ‘lay of the land’ view of computerized trading system behaviour/performance. Graphical visualization assists traders as traders are generally short on time, so a quick and efficient way to graphically communicate the recent past behaviour of computerized trading system to a trader would be very helpful and useful.

While there are a plethora of graphical user interfaces (GUIs) in the market for trading, these existing GUIs do not do a good job of graphically communicating the recent past behaviour of computerized trading system to a trader. In addition, while there are surveillance systems ion the market that are designed to highlight suspicious past trading behaviours to exchange venues (see, e.g., www.smarts.com.au.), these surveillance systems do not differentiate computerized trades from human originated trades, convey far less information than a trader seeks, and do not operate in the time constraints of real-time traded market.

### SUMMARY OF THE INVENTION

The present invention provides a quick and efficient way to graphically communicate the recent past behaviour of computerized trading system to a trader. In accordance with the principles of the present invention, a graphical user interface for computer trading is provided. A display represents best bid (buy) and best ask (offer) prices for an execution venue, with one axis of the display representing available prices, and another axis of the display representing time. The display comprises a sell area, a bid-ask spread, and a buy area. The boundary of the sell area and the bid-ask spread represents best ask (offer) price for the execution venue, and the boundary of the buy area and the bid-ask spread represents best bid (buy) price for the execution venue. First indicium on the display represents order executions and second indicium on the display represents posted orders. The first indicium has a position, a size, and a colour, with the position representing the time and price of the execution, the size representing the size or quantity of the execution, and the colour representing execution type and venue. The second indicium also has a position, a size, and a colour, with the position representing the price of the order; the size representing the duration of the order, and the colour of the second indicium representing the order type and venue. The second indicium further comprises a transparency representing the size or the quantity of units of the order.

### BRIEF DESCRIPTION OF THE DRAWINGS

FIG. 1 is a diagram showing a typical trade flow

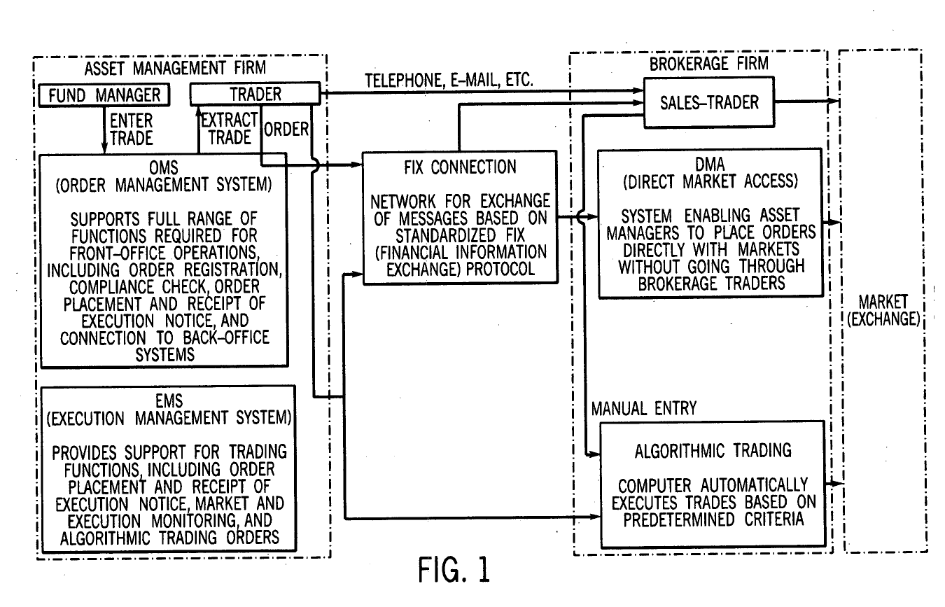

FIG. 2 is a chart showing the general relationship between a parent order and child orders.

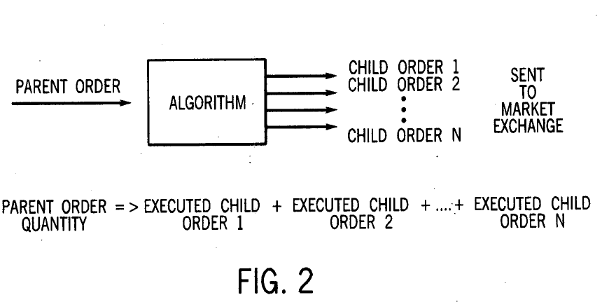

FIG. 3 is a schematic of a non-limiting example hardware architecture that can be used to run the system of the present invention.

FIG. 4 is an example of a price display in accordance with the principles of the present invention.

FIG. 5 is an example of a price display showing two computerized trading executions in accordance with the principles of the present invention.

FIG. 6 is an example of a price display showing off market executions in accordance with the principles of the present invention.

FIG. 7 is an example of a price display showing examples of different types of child orders in accordance with the principles of the present invention.

FIG. 8 is an example of a price display showing the computerized trading system child orders in accordance with the principles of the present invention.

FIG. 9 is an example of the price display of FIG. 8 together with computerized trading system executions in accordance with the principles of the present invention.

### DETAILED DESCRIPTION OF AN EMBODIMENT

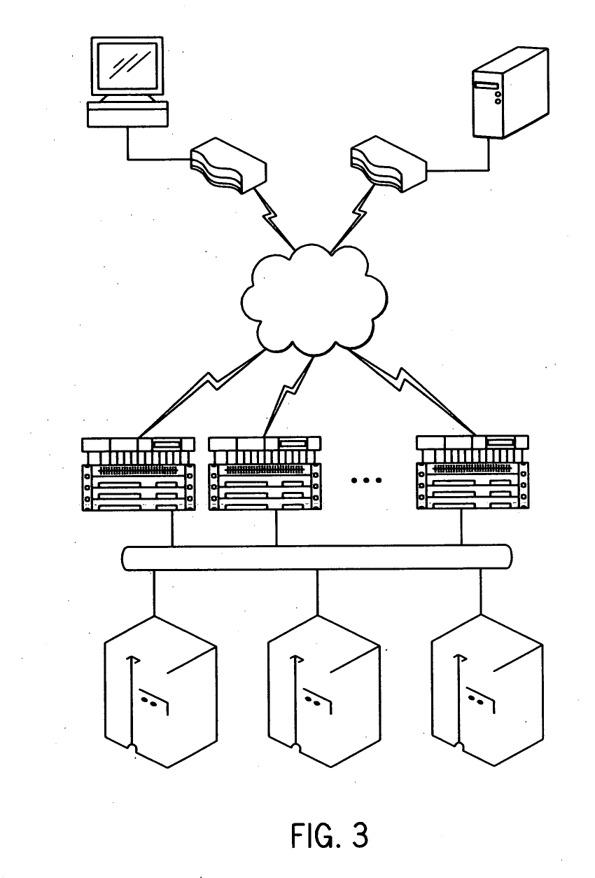

Referring to FIG. 3, a non-limiting example of a high level implementation that can be used to run a system of the present invention is seen. The infrastructure should include but is not limited to: wide-area network connectivity; network infrastructure; an operating system such as for example Redhat Linux Enterprise Linux AS Operating System available from Red Hat, Inc., 1801 Varsity Drive, Raleigh, N.C.; appropriate network switches and routers; electrical power (backup power); network backup hardware and software.

The match engine and administrative applications server can run for example on a Dell PowerEdge 2950 server with Single Processor, Dualcore Intel Xeon 5140 with 2.33 GHz, 1333 MHz FSB, 4 GB of RAM, 2×146 GIG Serial Attached SCSI Drives, Raid 1, available from Dell, Inc., One Dell Way, Round Rock, Tex. 78682. The database server can be run for example on an Dell PowerEdge 2950 server with Single Processor, Dualcore Intel Xeon 5140 with 2.33 GHz, 1333 MHz FSB, 4 GB of RAM, 2×73 GIG Serial Attached SCSI Drives, Raid 1, also available from Dell, Inc.

In accordance with the principles of the present invention, a graphical user interface for computer trading is provided. The graphical user interface for computer trading of the present invention includes a price display for rendering elements of computerized trading system behaviour. The graphical user interface of the present invention further includes first indicium of different size and colour representing child order executions achieved by the computerized trading system. The position of the first indicium on the price display is determined from the time and price of the execution. The size of the first indicium is proportional to the size or quantity of the execution; thus, for example, larger executions are represented with bigger first indicium. The colour of the first indicium is determined from the different execution venue: for example, on-public market (e.g., on NYSE) or off-public market (e.g., on an ATS or ECN).

In one example, there can be three types of categories for on-market executions and one type of off-market executions. Off-market executions are executions off the host public exchange. The off-market executions also can be shown on the price display of the present invention by using different colours to on-market executions of the computerized trading system.

Second, different indicium can represent the child orders submitted by the computerized trading system to public or off-public (ATSs or ECNs) venues which are not yet executed. The position of the second indicium along the price axis can represent the price of the child order and the length of the second indicium can represent the duration of the child order. When used herein, duration refers to the time the child orders remain active in the market without being cancelled or executed completely. The colour of the second indicium can represent the posted venue and the order type of the computerized trading system child order. Examples of different order types can include: call auction order types, including but not limited to ‘market (limit) on open’ and ‘market (limit) on close’ orders, which are used during opening and closing auctions; continuous session orders, such as ‘limit orders’, which are specified with a limit price, which puts a limit on the price for which the order can be executed; ‘hidden limit orders’, which remain invisible to other market participants; so called ‘iceberg’ limit orders, which are limit orders with only a small fraction of the total child order quantity visible to the rest of the market participants

The solidness or transparency of the second indicium can represent the size of the of the posted child order. The size of the child order can be represented as a percentage of the parent order quantity, such as between 0%-100%. The size of the child order also can be represented as a percentage of the typical market order size for the traded object, expressed as a percentage.

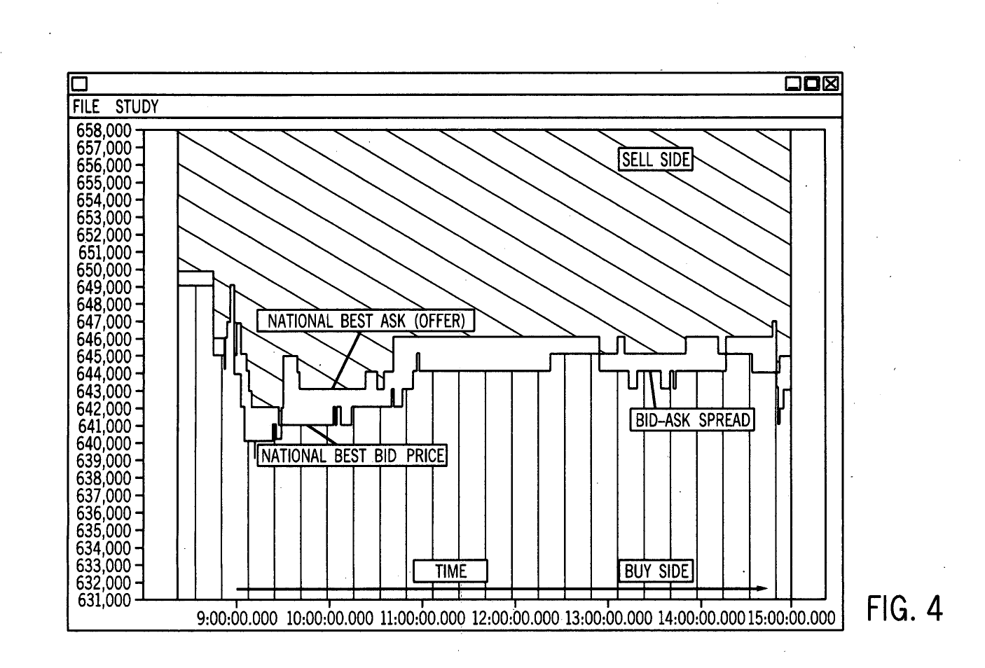

Referring to FIG. 4, an example of a price display of the present invention is seen. The price display is a two-dimensional representation of the national best bid (buy) and national best ask (offer) prices. One axis can represent the range of available prices, another axis can represent time, and the internal display area can be comprised of the sell side (in this example, the top half); the bid-ask spread; and the buy side (in this example, the bottom half). The national best ask price is at the boundary of the sell side and the bid-ask spread. The national best ask price represents the lowest price which is available across all the publicly displayed execution venues. The best bid price is at the boundary between the buy side and the bid-ask spread. The best bid price represents the highest price which is available across all the publicly displayed execution venues. The range of available prices in the market is represented on one axis (in this example, the vertical axis on the left), and time is represented on the other axis (in this example, the horizontal axis on the bottom).

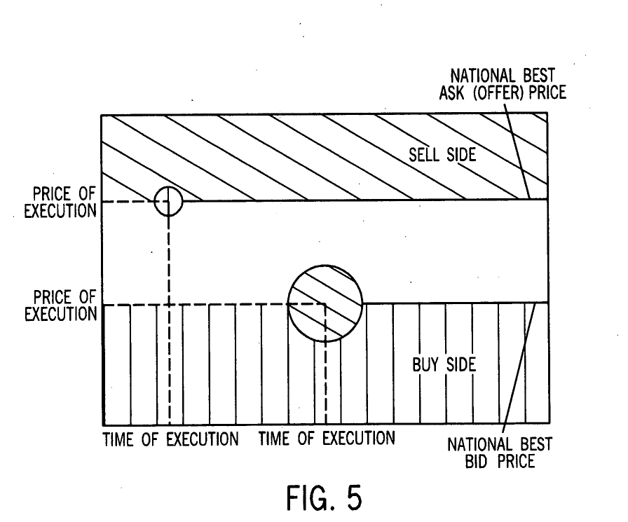

Order executions, such as in this example child order executions, are represented as the first indicium such as for example circles on the price display of FIG. 5. Computerized trading system executions can include the following characteristics: price, time, quantity, venue, and type. Each characteristic can be represented with different properties of the circle: for example, the vertical position of the circle on the price axis can represent execution price; the horizontal position of the circle on the time axis can represent the execution time; the area (or size) of the circle can represent the execution quantity; and the colour of the circle can represent the execution venue/type. Examples of types of executions can include executions on the national best bid price; executions on the national best ask price; auction executions; and off-public market execution.

Referring to FIG. 5, two computerized trading system executions are seen. The relatively larger execution (in this example, green) is on the best bid price, and the relatively smaller execution (in this example, red) is on the best ask price. The colour of the circle represents child order execution venue/type: for example on-public market (or on primary exchange) executions on the national best bid can be coloured green as seen in FIG. 4. Executions on-public market at the national best bid price can be coloured in the same colour as the sell side. Executions on-public market at the national best ask can be coloured red as seen in FIG. 5. Executions on the best ask can be coloured in the same colour as the buy side. Call auction executions refer to computerized trading system executions that occur at the start or at the end of the trading session. Call auction executions can be coloured in a different colour to the executions on-public market executions at the national best bid or the best ask. Off-public (or primary) market executions can be represented with a different colour to the other execution types. Off-public market executions can fall inside the bid-ask spread as these executions can interact with hidden liquidity (i.e., posted orders which are not visible to the public) which can be found in the order books of private ATSs or ECNs.

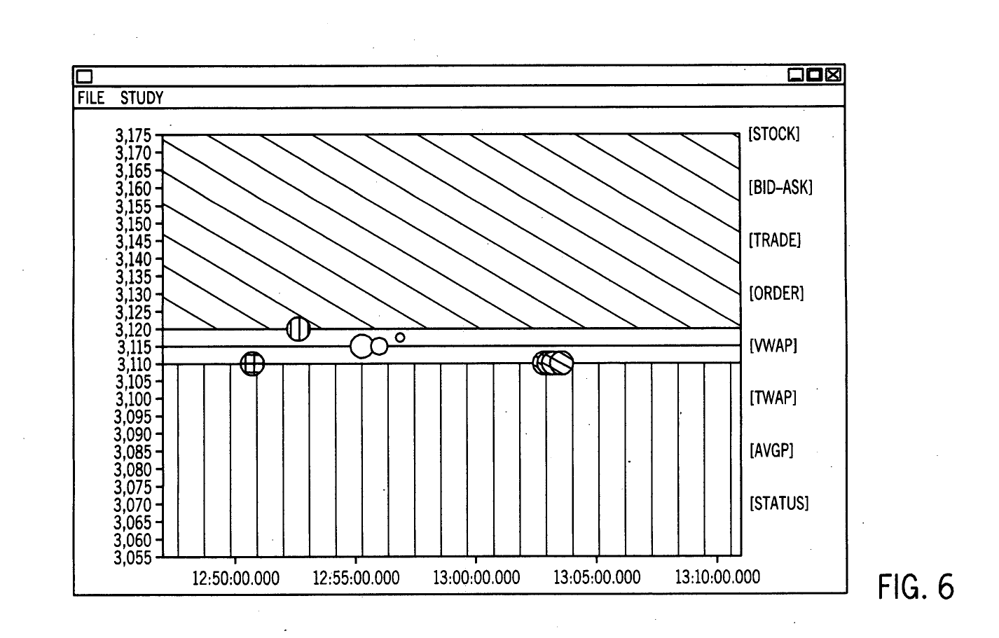

FIG. 6 shows the following examples of the types of computerized trading system child executions: one on-market call auction execution (yellow) at price 3,110; one on-public market buyer initiated execution (red) at price 3,120 at the national best offer; four on-public market executions (green) at price 3,110 at the national best bid; and three off-public market executions (white) at prices 3,115, 3,115 and 3,118 yen.

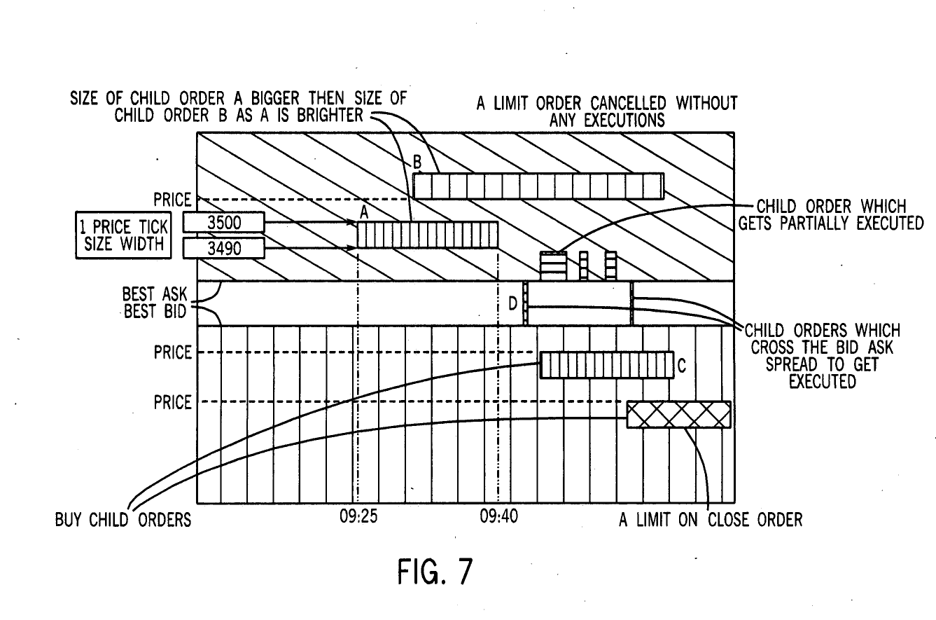

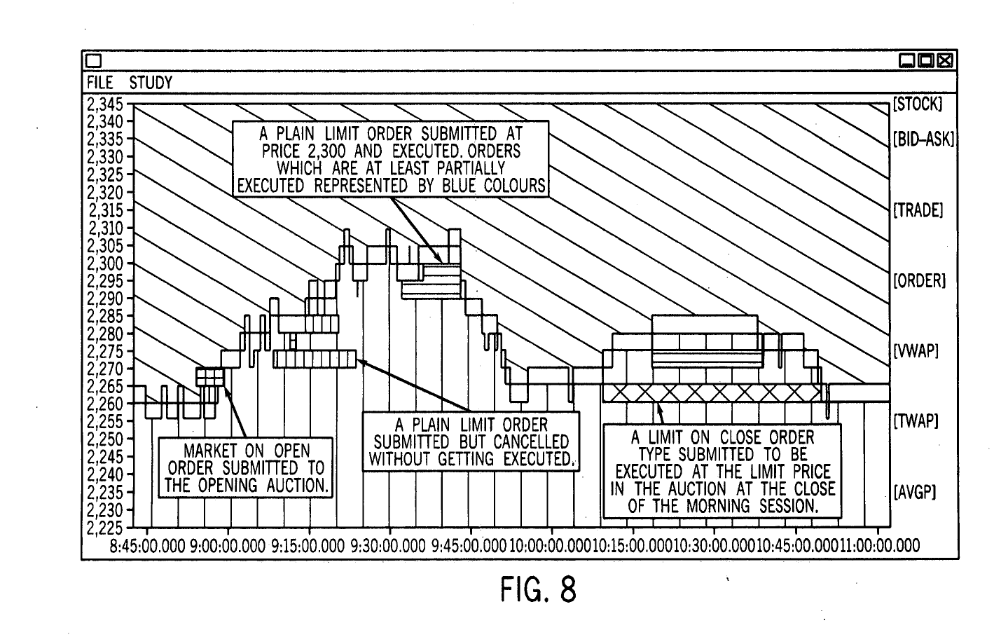

Orders, such as in this example child orders which are sent to different execution venues by the computerized trading system but not yet executed can be represented as second indicium such as for example rectangles on the price display of FIG. 7. The computerized trading system orders can have the following characteristics: price, start time, end time, quantity, venue, and type. The position of the top side of the rectangle on the price co-ordinate can represent the price for buy child orders, and the position of the bottom side of the rectangle on the price co-ordinate can represent the price for sell child orders. The duration can be represented by the length of the rectangle. The colour of the rectangle can represent the exchange venue/order type. The solidness or transparency of the colour of the rectangle can represent the quantity of the computerized trading system child order. FIG. 8 shows examples of different types of child orders. Child orders a, b are buys and child order c is a sell order.

The price of a child order can be represented on the price display. The bottom side of the child order rectangle can represent the price of sell orders, on the price axis co-ordinate. In FIG. 7, child order price would be 3,490 yen. See child order A, B in the price display. The top side of the child order rectangle can represent the price of buy orders, on the price axis co-ordinate. See child order C in the price display.

The length of the rectangle can represent the duration of the child order. For example, the duration of the child order A in FIG. 6 is 15 minutes. The child order rectangle colours represent the venues and types and outcomes of the child orders that the computerized trading system sends to the various execution venues including the ATSs or ECNs as well as the host or primary public exchange. The types of child orders vary depending on the host exchange. For example, there are several types of basic orders that can be found on most primary public exchanges like market (limit) on open, market (limit) on close, basic limit order, and market orders. The colours that can be used in for the different computerized trading system orders can depend on the following examples:
Market on Open (sent to the opening call auction at the primary exchange)→represented as yellow rectangles
Market on Close (sent to the closing call auction at the primary exchange)→represented as yellow rectangles
Limit on Open (sent to the opening call auction at the primary exchange)→represented as orange rectangles
Limit on Close (sent to the closing call auction at the primary exchange)→represented as orange rectangles
Limit Order (during the continuous session sent to the host primary public exchange)→Represented as Blue or Pink depending on if the order is partially executed or not, respectively.
Market Order (during the continuous session sent to the host primary public exchange)→Blue as a market order is at least partially executed.
Orders which are sent to alternative venues (other than the host or public exchange)→Represented with alternative colour schemes.

Child orders which are sent to the public primary exchange which are cancelled without getting any executions and child orders that are at least partially executed can be differentiated by using different colours, for example pink or blue. The quantity or size of a child order can be represented by the solidness or transparency of the colour used for the rectangle that represents that child order. Examples of scales that can be used for determining the transparency can include: relative to the original parent order size, child orders which are a bigger percentage of the original parent order size are represented with brighter more solid colours; relative to the typical posted size in the host exchange, child orders which are a bigger percentage of the typical volume posted on the host exchange are represented with brighter (or more solid) colours.

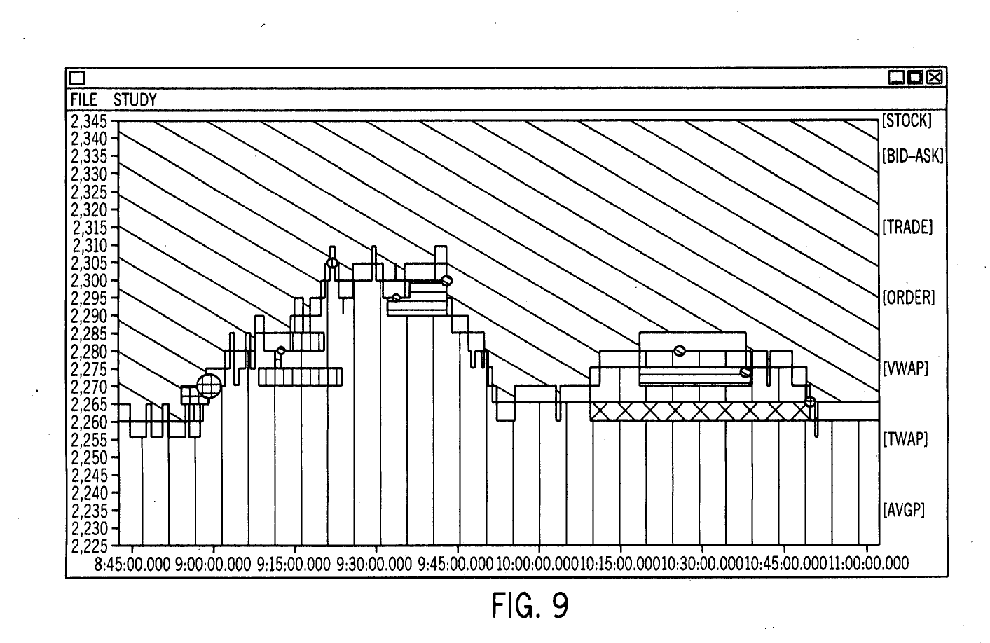

FIG. 8 shows a snapshot of the display, from the computerized trading system visualization system, only showing the computerized trading system child orders (not the executions). FIG. 9 shows the display of FIG. 8 together with the computerized trading system executions (circles).

While the invention has been described with specific embodiments, other alternatives, modifications, and variations will be apparent to those skilled in the art. For example, as is clear to one of skill in the art, the present invention is not limited to any given set of colours or indicium; it is not the colours or indicium themselves but the representation of the child orders using separate colours and indicium. In addition, while the embodiment described herein uses child orders, the present invention is not limited to child order but would be application to any orders as well. Accordingly, it will be intended to include all such alternatives, modifications and variations set forth within the spirit and scope of the appended claims.

What is claimed is:

1. A graphical user interface for computer trading comprising:
a display for representing best bid and best ask prices for an execution venue;
first indicium on the display representing an order execution, the first indicium having a position, a size, and a colour, one of the position, size or colour of the first indicium representing time and price of the order execution, another of the position, size or colour of the first indicium representing size or quantity of the order execution, and another of the position, size or colour of the first indicium representing order execution type and execution venue;
second indicium on the display represent an order, the second indicium having a position, a size, and a colour, one of the position, size or colour of the second indicium representing price of the order; another of the position, size or colour of the second indicium representing duration of the order, and another of the position, size or colour of the second indicium representing order type and execution venue.

2. The graphical user interface for computer trading of claim 1 wherein the second indicium further comprises a transparency representing size of the order

3. The graphical user interface for computer trading of claim 1 further wherein the first indicium comprises a circle representing an order execution.

4. The graphical user interface for computer trading of claim 1 further wherein the second indicium comprise a rectangle representing an order.

5. The graphical user interface for computer trading of claim 4 further wherein the length of the rectangle represents duration of the order.

6. The graphical user interface for computer trading of claim 4 further wherein the position of the top side of the rectangle represents price for buy orders and the position of the bottom side of the rectangle represents price for sell orders.

7. The graphical user interface for computer trading of claim 1 further wherein the colour of the first indicium is determined from on-market or off-market execution.

8. The graphical user interface for computer trading of claim 1 further wherein execution on a best bid in the first indicium is green and execution on a best ask in the first indicium is red.

9. The graphical user interface for computer trading of claim 1 further wherein the vertical position of the first indicium represents execution price and the horizontal position of the first indicium represents execution time.

10. The graphical user interface for computer trading of claim 1 further wherein the size of the first indicium is proportional to quantity of execution.

11. The graphical user interface for computer trading of claim 1 further wherein the execution type is selected from the group comprising executions on the best bid price, executions on the best ask price, auction executions, and off market execution.

12. The graphical user interface for computer trading of claim 1 further wherein the size of the second indicium is represented as a percentage of a typical market order size.

13. The graphical user interface for computer trading of claim 1 further wherein the colour of the second indicium represents order type and posted exchange venue of the order selected from the group comprising public primary ‘market on open’ orders, public primary ‘market on close’ orders, public primary market ‘limit on open’ orders, and limit on close orders.

14. The graphical user interface for computer trading of claim 1 further wherein a market on open order is yellow.

15. The graphical user interface for computer trading of claim 1 further wherein a market on close order is yellow.

16. The graphical user interface for computer trading of claim 1 further wherein a limit on open order is orange.

17. The graphical user interface for computer trading of claim 1 further wherein a limit on close order is orange.

18. The graphical user interface for computer trading of claim 1 further wherein a partially executed limit order is blue.

19. The graphical user interface for computer trading of claim 1 further wherein a not partially executed limit order is pink.

20. The graphical user interface for computer trading of claim 1 further wherein a partially executed market order is blue.

21. The graphical user interface for computer trading of claim 1 further wherein the order is a child order.

22. The graphical user interface for computer trading of claim 21 further wherein the size of the second indicium is represented as a percentage of parent order quantity.

23. The graphical user interface for computer trading of claim 21 wherein the second indicium further comprises a transparency representing size of the order, and transparency is determined from the group comprising child orders which are a bigger percentage of the original parent order size represented with brighter or more solid colours and child orders which are a bigger percentage of the typical volume posted on the host exchange represented with brighter or more solid colours.

24. The graphical user interface for computer trading of claim 1 further wherein the display comprises a sell area, a bid-ask spread, and a buy area; the boundary of the sell area and the bid-ask spread represents best ask (offer) price for the execution venue; and the boundary of the buy area and the bid-ask spread represents best bid (buy) price for an execution venue.

25. A graphical user interface for computer trading comprising:
a display for representing best bid and best ask prices, one axis of the display representing available prices, another axis of the display representing time;
the display comprising a sell area, a bid-ask spread, and a buy area;
the boundary of the sell area and the bid-ask spread represents best ask price; and
the boundary of the buy area and the bid-ask spread represents best bid price

26. The graphical user interface for computer trading of claim 25 further wherein the vertical axis represents available prices and the horizontal axis represents time.

27. The graphical user interface for computer trading of claim 25 further wherein the top comprises the sell side and the bottom comprises the buy side.

28. The graphical user interface for computer trading of claim 25 further comprising a first indicium on the display representing an order execution, and a second indicium on the display represent an order.

29. The graphical user interface for computer trading of claim 28 further wherein the first indicium has a position, a size, and a colour, and one of the position, size or colour of the first indicium represents time and price of the order execution, another of the position, size or colour of the first indicium represents size or quantity of the order execution, and another of the position, size or colour of the first indicium represents order execution type.

30. The graphical user interface for computer trading of claim 28 further wherein the second indicium has a position, a size, and a colour, and one of the position, size or colour of the second indicium representing price of the order; another of the position, size or colour of the second indicium representing duration of the order, and another of the position, size or colour of the second indicium representing order type.

31. The graphical user interface for computer trading of claim 30 wherein the second indicium further comprises a transparency representing the size of the order.

32. The graphical user interface for computer trading of claim 28 further wherein the first indicium comprises a circle representing an order execution.

33. The graphical user interface for computer trading of claim 28 further wherein the second indicium comprise a rectangle representing an order.

34. A graphical user interface for computer trading comprising:
a display for representing best bid and best ask prices, one axis of the display representing prices, another axis of the display representing time, the display comprising a sell area, a bid-ask spread, and a buy area;
a first indicium on the display representing an order execution; and
a second indicium on the display representing an order.

35. The graphical user interface for computer trading of claim 34 further wherein an executions on best bid is coloured in the same colour as the sell side, and an executions on best ask is coloured in the same colour as the buy side.

36. The graphical user interface for computer trading of claim 34 further wherein an off-market execution is inside the bid-ask spread.

37. The graphical user interface for computer trading of claim 34 further wherein the boundary of the sell area and the bid-ask spread represents best ask price and the boundary of the buy area and the bid-ask spread represents best bid price.

38. The graphical user interface for computer trading of claim 34 further wherein the first indicium has a position, a size, and a colour, and one of the position, size or colour of the first indicium represents time and price of the order execution, another of the position, size or colour of the first indicium represents size or quantity of the order execution, and another of the position, size or colour of the first indicium represents order execution type.

39. The graphical user interface for computer trading of claim 34 further wherein the second indicium has a position, a size, and a colour, and one of the position, size or colour of the second indicium representing price of the order; another of the position, size or colour of the second indicium representing duration of the order, and another of the position, size or colour of the second indicium representing order type.

40. The graphical user interface for computer trading of claim 39 wherein the second indicium further comprises a transparency representing size of the order.

41. The graphical user interface for computer trading of claim 34 further wherein the first indicium comprises a circle representing an order execution.

42. The graphical user interface for computer trading of claim 34 further wherein the second indicium comprise a rectangle representing an order.
